(19) United States
(12) Patent Application Publication
(10) Pub. No.: US 2006/0230048 A1
(43) Pub. Date: Oct. 12, 2006

(54) Method and apparatus for object discovery agent based mapping of application specific markup language schemas to application specific business objects in an integrated application environment

(75) Inventors: Yury Kosov, San Francisco, CA (US); Thomas Pollinger, Cupertino, CA (US)

Correspondence Address: DUKE W. YEE, P.O. BOX 802333, YEE & ASSOCIATES, P.C., DALLAS, TX, 75380, US

(73) Assignee: International Business Machines Corporation, Armonk, NY (US)

(21) Appl. No.: 11/101,867

(22) Filed: Apr. 8, 2005

(51) Int. Cl. G06F 17/00

(52) U.S. Cl. 707/100

(57) ABSTRACT

A method, an apparatus, and computer instructions are provided for object discovery agent (ODA) based mapping of application specific markup language schemas to application specific business objects using an appropriate ODA. A generic ODA application specific information (ASI) builder is added to a business object application specific information (BO ASI) resolver for selecting specific ODA ASI builder from a plurality of registered builders. Upon receiving schema meta business objects (BOs), generic ODA ASI builder sends generated BOs to specific ODA ASI builder, which prepares configuration data structure understood by a specific ODA. Specific ODA uses data structure to generate application specific BOs. A BO reader creates ODA meta BOs from application specific BOs. The generic ODA ASI builder matches ODA meta BO with schema meta BO. Matched parts are ported to a target meta BO. Unmatched parts are resolved by transformation rule or user input. Application specific target meta BOs are sent back to BO ASI resolver.

### CROSS-REFERENCE TO RELATED APPLICATIONS

The present invention is related to the following applications entitled Using Schemas to Generate Application Specific Business Objects for Use in an Integration Broker, Ser. No. ______ attorney docket no. SVL920040075US1 filed on ______.

### BACKGROUND OF THE INVENTION

1. Technical Field

The present invention relates to an improved network data processing system. In particular, the present invention relates to an integrated application environment in a network data processing system. Still more particular, the present invention relates to object discovery agent (ODA) based mapping of application specific markup language schemas to application specific business objects in an integrated application environment.

2. Description of Related Art

In an integrated application environment, an integration server integrates different types of applications and shares business objects among these applications. In this environment, application specific business objects are used to model a variety of application types. These application types include database applications, enterprise applications, etc. An adapter of a target application, such as database application, may utilize application specific application information (ASI) fields to relate business objects to application artifacts. Application specific information fields provide mapping of business object fields to corresponding field in the application specific data structure of the target application. Application types may employ a variety of application artifacts, including complex artifacts that require additional constructs besides the ASI fields. Examples of additional constructs include additional configuration objects, stored procedures, and helper functions or classes.

Generally, application artifacts may be exposed as annotated markup language schemas, which may be imported into the integrated application environment by first creating a base business object structure from the schema structure. The application specific information fields of the base business object structure may then be augmented based on the schema annotations. For complex artifacts that require additional constructs, it may be beneficial to provide the business object structure itself to the adapter, because complicated structures require substantial development efforts. In addition, different revisions of the adapter may lead to changes of the business object structure.

One way to provide the business object structure to the adapter is by using an object discovery agent (ODA), which generates business objects and their supporting structures for an adapter to communicate with a target application. To build application business objects for a given application adapter that requires additional supporting classes, a corresponding application ODA is used to generate matching business objects with matching application specific information and supporting data structures. Thus, access to the application is needed in order for the object discovery agent to work.

If the business artifacts are used in a larger business context such as a business integration process, importing by the ODA is a highly manual process. First, the ODA that matches the schema for the business object artifact used in the business integration process has to be found, configured and manually run by the user. In addition, since ODA works directly with the target application's native interface, the relation to the original annotated markup language schema is lost. Thus, an annotated schema that represents database tables and columns may never be applied to a markup language document, since the relation to the annotated schema is lost. Rather, the ODA merely includes an abstraction of the database itself.

Currently, there is no existing mechanism that recovers lost schema information from business objects that are generated by an ODA, which is not based on the schema itself. The lost schema information is needed by business processes that are expressed in terms of representing schema instead of generated business objects.

In addition to ODA, another way of providing the business object structure to the adapter is by using a generic importer that can import neutral schema and other business process artifacts. The generic importer utilizes the ODA to generate application business objects and replaces the neutral business objects with the generated application business objects. However, the replacement of neutral business objects is tedious to perform and may be complex, since the naming or structure between neutral and application business objects are different.

Therefore, it would be advantageous to have an improved method for object discovery agent based mapping of application specific markup language schemas to application specific business objects, such that schema information may be preserved even with the use of ODAs.

### SUMMARY OF THE INVENTION

The present invention provides a method, an apparatus, and computer instructions for object discovery agent based mapping of application specific markup language schemas to application specific business objects. A schema resolver is provided to detect an application specific markup language schema and generate a set of schema meta business objects that hold references to metadata of the schema. A business object application specific information (BO ASI) resolver then identifies a generic object discovery agent application specific information (ODA ASI) builder.

The identified generic builder in turn identifies a specific ODA ASI builder based on an application type. The identified specific ODA ASI builder reads configuration data of the schema meta business objects (BOs), and generates a data structure understandable by a specific ODA. The specific ODA then generates a set of application specific BOs using the data structure and a business object reader is used to create ODA meta BOs. The generic builder matches the schema meta BOs against ODA meta BOs. Optionally, the specific ODA ASI builder is used to fine-tune a set of target meta business objects, and a business object writer may be used to write out the set of target meta business objects and configuration data structures.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with an illustrative embodiment of the present invention;

FIG. 3 is a block diagram illustrating a data processing system in which the present invention may be implemented;

FIG. 4 is a diagram illustrating an integrated application environment in accordance with an illustrative embodiment of the present invention;

FIG. 5 is a diagram illustrating a generic framework for reading markup language schemas to form business objects in accordance with an illustrative embodiment of the present invention;

FIG. 6 is a diagram illustrating a generic framework for reading markup language schemas with added generic and specific BO ASI builders in accordance with an illustrative embodiment of the present invention;

FIG. 7 is a diagram illustrating an exemplary schema meta business object generated by a schema resolver in accordance with an illustrative embodiment of the present invention;

FIG. 8 is a diagram illustrating an exemplary application specific business object in accordance with an illustrative embodiment of the present invention;

FIG. 9 is a functional diagram illustrating an exemplary mapping of application specific business object to meta business object generated by a BO reader in accordance with an illustrative embodiment of the present invention;

FIG. 10 is a functional diagram illustrating an exemplary mapping of schema meta BOs to ODA meta BOs in accordance with an illustrative embodiment of the present invention;

FIG. 11A is a flowchart of an exemplary process for object discovery agent based mapping of application specific markup language schemas to application specific business objects using an appropriate ODA in accordance with an illustrative embodiment of the present invention; and

FIG. 11B is a flowchart of the exemplary process in continuation of FIG. 11A for object discovery agent based mapping of application specific markup language schemas to application specific business objects using an appropriate ODA in accordance with an illustrative embodiment of the present invention.

### DETAILED DESCRIPTION OF THE PREFERRED EMBODIMENT

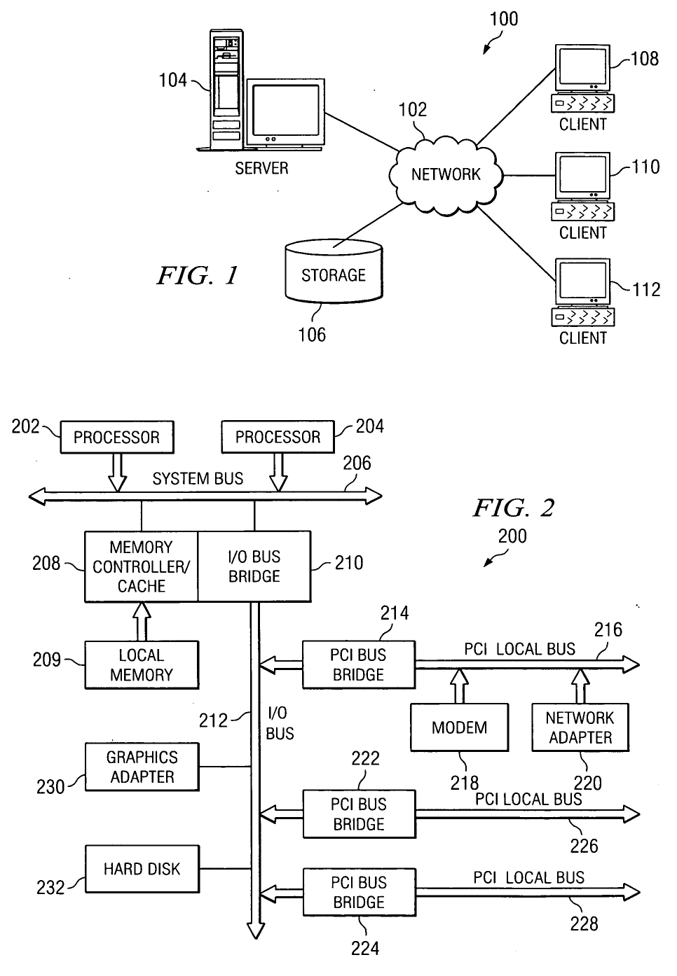

With reference now to the figures, FIG. 1 depicts a pictorial representation of a network of data processing systems in which the present invention may be implemented. Network data processing system 100 is a network of computers in which the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with an illustrative embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. Memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

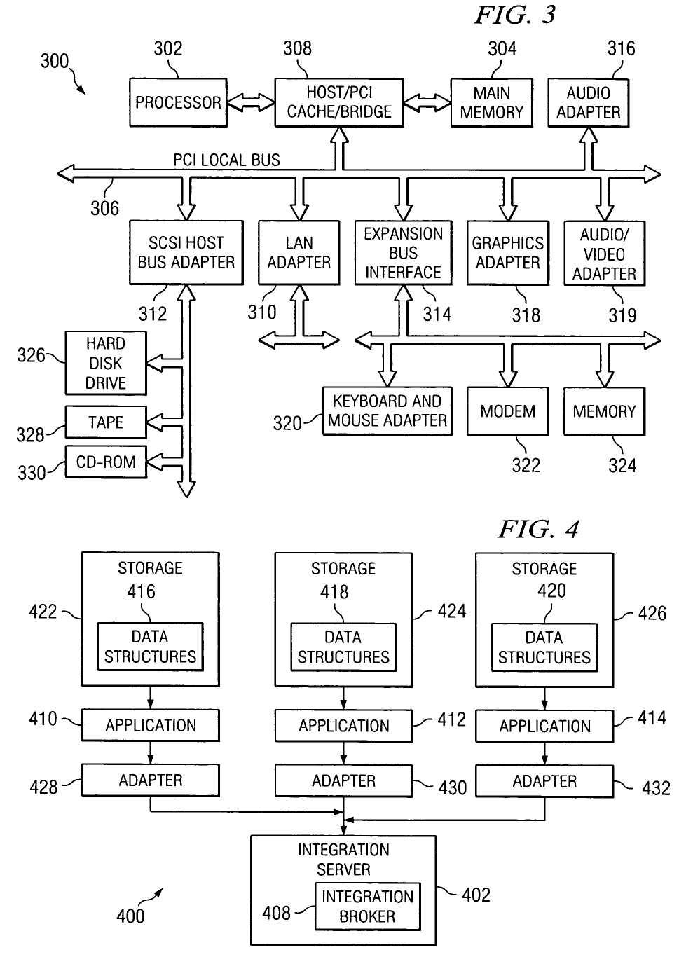

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object-oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand-held computer in addition to taking the form of a PDA. Data processing system 300 also may be a kiosk or a Web appliance.

As described in related patent application, entitled “Using Schemas to Generate Application Specific Business Objects for Use in an Integration Broker,” incorporated by reference above, when a source application wants to communicate with a destination application in an integrated application environment, adapters are used to transform data in the source format to the destination format. Specifically, an adapter of the source application may convert proprietary data or application specific business objects to generic business objects understood by the integrated environment. Business objects are containers that hold fields of any type.

Business object fields may include a field type, a field name, and a field ASI. Field name indicates the name of the field, such as street. Field type indicates a type of the field, for example, a string, an integer, or a long. Field ASI is typically empty if the business object is a generic business object or it may hold information for its matching application adapter. A user may also include comments for each field to indicate status, such as whether the field is a foreign key, a key, a default value, or whether the field may be null or not. An instance of the business object definition hold instance values that conform to the type defined in the business object definition.

Upon receiving the generic business objects, an adapter of the destination application may convert the generic business objects back to application specific business objects for the destination application. In this way, collaboration may be achieved between the source and destination applications, since adapters normalize their underlying application.

Turning now to FIG. 4, a diagram illustrating an integrated application environment is depicted in accordance with an illustrative embodiment of the present invention. As depicted in FIG. 4, integration application environment 400 includes integration server 402. Integration server 402 may be implemented as data processing system 200 in FIG. 2.

Integration server 402 includes integration broker 408, which provides services for transfer of data in application specific business objects among applications 410, 412, and 414. Applications 410, 412, and 414 are clients for integration broker 402 and maintain data in application specific data structures 416, 418, and 420 respectively. Application specific data structures 416, 418, and 420 may reside in vendor specific databases, such as storage 422, 424, and 426, or tied to an application that may not have storage attached.

When a source application, such as application 410, receives a new customer address, adapter 428 reads the customer with the new customer address and transforms it into an application specific business object. Adapter 428 then sends the application specific business object to integration broker 408. Integration broker 408 includes a map that maps the application specific business object into a generic business object, which represents relevant parts of the customer field in a normalized way.

The generic business object does not have any application specific information fields and is used in generic collaborations, while the application specific business object looks structurally the same as the generic business object, but with ASI fields initialized to work with adapter 428. Adapter 428 transforms application specific business objects to a format understood by application 410. Examples of formats include XML, database SQL queries, IDOC, BAPI for SAP, simple output text files or direct connection to a third-party vendor application programming interface.

A collaboration mechanism within integration broker 408 that provides synchronization between the source adapter and the target adapter accepts the generic business object, and sends an update request to target adapter 430 of target application 412.

Before returning the object to target adapter 430, integration broker 408 maps the generic object into the target application specific business object. Once the application specific business object is received by target adapter 430, target adapter 430 sends the updated address information in the target application's format to target application 412.

While, in this illustrative embodiment, three adapters are provided to transfer data between data structures, any number of additional adapters may be provided to transfer data between additional data structures without departing the spirit and scope of the present invention. In addition, adapters may be implemented as a standalone adapter or tied to a target application that may not have a storage device attached. An example of a standalone adapter is a source adapter, which reads temperature from a measuring device. An example of an adapter tied to a target application is a front end that is tied to some other application.

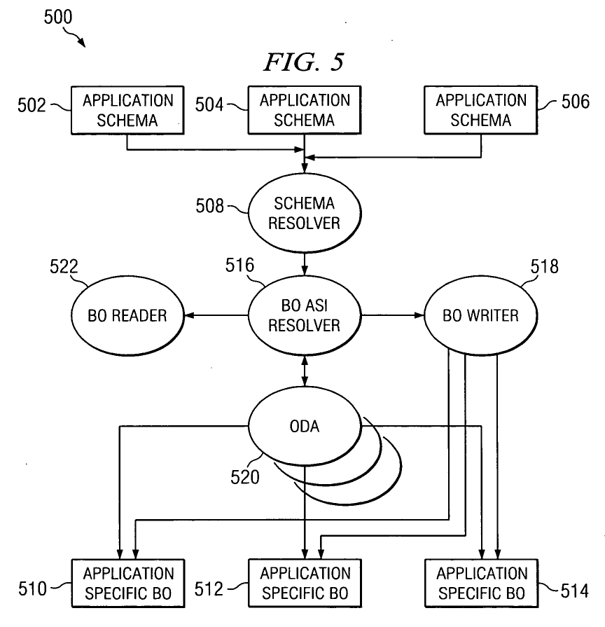

Turning now to FIG. 5, a diagram illustrating a generic framework for reading markup language schemas to form business objects is depicted in accordance with an illustrative embodiment of the present invention. As depicted in FIG. 5, in integration broker 500, application markup language schemas 502, 504, and 506 may be provided to define the structure and formats of application specific data structures, such as data structures 416, 418, and 420 in FIG. 4.

Schemas 502, 504, and 506 are parsed by schema resolver 508 to generate base structures for application specific business objects 510, 512, and 514. These base structures are known as meta business objects (BOs). Meta BOs hold information for the application specific business objects 510, 512, 514 as well as references to the original source schemas 502, 504, and 506. Schemas 502, 504, and 506 are then interpreted by business object ASI resolver 516 to populate application specific information (ASI) fields of the application specific business objects 510, 512, and 514. ASI fields provide information necessary to configure the target application. For example, in case of a target database application, ASI fields may include the database name, table names, and column names.

If BO ASI resolver 516 is able to populate the ASI fields, BO ASI resolver 516 populates the ASI fields and passes the application specific business objects 510, 512, and 514 to business object writer 518. BO writer writes out the business objects with ASI fields. Alternatively, if BO ASI resolver 516 is not able to populate the ASI fields, BO ASI resolver 516 locates responsible object discovery agents (ODAs), such as ODAs 520, that are able to generate the desired business object structures.

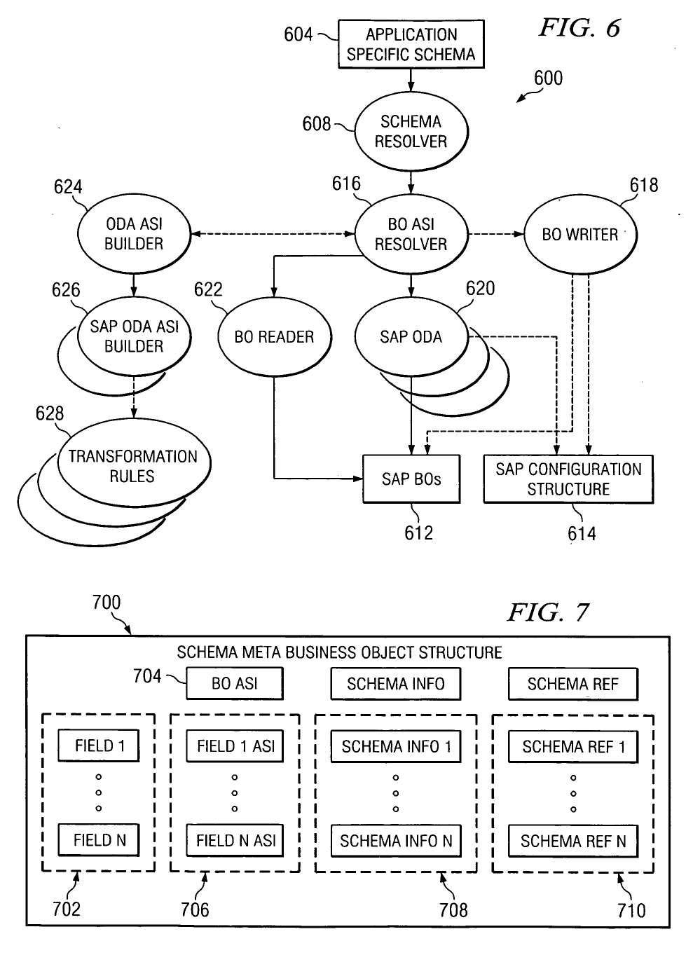

BO ASI resolver 516 may also be extended to plug in additional specific ASI builders that are able to interpret a particular form of schema definition. More detail regarding the extension of BO ASI builder 516 is discussed in FIG. 6. For business objects that are generated by object discovery agents (ODAs) 520, the business objects are fed back to business object reader 522 to be augmented by the schema part, such that subsequent system that expresses itself in terms of respective schema may access the business objects, for example, XPath system.

The present invention provides a method, an apparatus, and computer instructions for ODA based mapping of application specific markup language schemas to application specific business objects in an integrated application environment. In an illustrative embodiment, the present invention extends the functionality of the business object application specific information (BO ASI) resolver to plug in a generic business object application specific information (BO ASI) builder for object discovery agents (ODAs). The generic BO ASI builder provides base functionality to support a variety of ODAs.

With the generic BO ASI builder, complex business artifacts that use ODA to generate business objects for adapters may be imported by the generic schema importer. In addition, the generic BO ASI builder enables the generic meta business objects to be synchronized with the ODA generated business object structures. Furthermore, the generic BO ASI builder enables support for all ODAs once the ODAs are correctly configured.

Turning now to FIG. 6, a diagram illustrating a generic framework for reading markup language schemas with added generic and specific BO ASI builders is depicted in accordance with an illustrative embodiment of the present invention. As shown in FIG. 6, integration broker 600 is similar to integration broker 500 in FIG. 5, except that generic ODA ASI builder 624 is added to communication with BO ASI resolver 616. Generic ODA ASI builder synchronizes meta business objects generated by BO reader 622 with meta business objects generated by the schema resolver 608.

In addition, one or more specific ODA ASI builders, including SAP ODA ASI builder 626, may be registered with generic ODA ASI builder 624 for different application types. Specific ODA ASI builder 626 reads configuration data from the annotated schema in order to configure specific ODA 620. Optionally, specific ODA ASI builder 626 may fine tune the meta business objects and/or the ODA generated business objects.

When application specific annotated schema 604 is provided to schema resolver 608, schema resolver 608 parses the schema and generates meta business objects (BOs) that are annotated with the source schema. Meta business objects are object representations of the schema format and may include all annotations, commons, names, rules, and other hierarchical information of the schema. Meta business objects are also known as schema meta BOs. More detail regarding meta BOs generated by schema resolver is discussed in FIG. 7.

Once the meta BOs are generated, schema resolver 608 passes the objects to BO ASI resolver 616, which locates registered BO ASI builders that are able to interpret particular forms of schema definitions and determines if a generic ODA ASI builder, such as generic ODA ASI builder 624, is present to handle the meta BOs. In turn, generic ODA ASI builder 624 queries all of its registered ODA ASI builders and returns a specific ODA ASI builder for the application type, for example, SAP ODA ASI builder 626. Other application types may be supported by registering additional application specific ODA ASI builders with generic ODA ASI builder 624.

Once application specific ODA ASI builder 626 is located, the BO ASI resolver 616 sends the meta BOs to generic ODA ASI builder 624, which in turn sends them to specific ODA ASI builder 626. Specific ODA ASI builder 626 reads all the configuration data from the meta BOs and prepares a data structure that can be understood by the specific ODA. An example of a specific ODA is SAP ODA 620, which generates business objects and their supporting structures for an adapter to communicate with a SAP application. Generic ODA ASI builder 624 also constructs specific ODA ASI builder 626 to use the specific ODA 620.

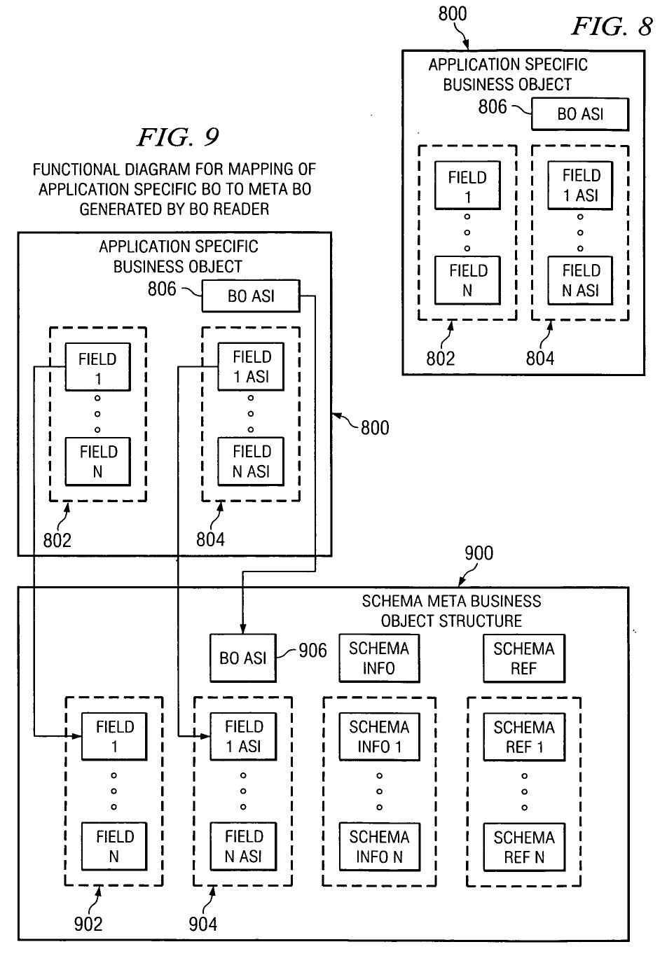

Once specific ODA ASI builder 626 is constructed and configured, generic ODA ASI builder 624 sends it to BO ASI resolver 616. BO ASI resolver 616 then calls the specific ODA 620 with all the needed configuration data structure. Specific ODA 620 generates all the application specific business objects and additional structural elements and places them in a known target directory. More detail regarding specific ODA and application specific business object is discussed in FIG. 8. BO ASI resolver 616 then takes the application specific business objects from the directory and sends them to BO reader 622, which creates meta BOs from the application specific business objects. These meta BOs are known as ODA meta BOs. More detail regarding meta BOs generated by the BO reader is discussed in FIG. 9.

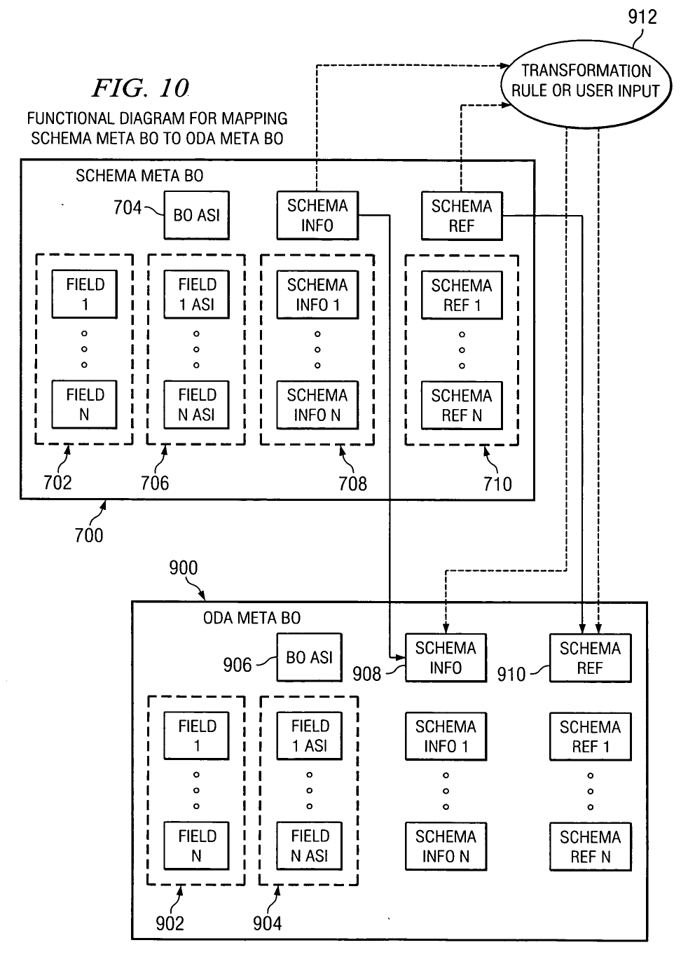

BO ASI resolver 616 then sends the ODA meta BOs and the schema meta BOs to generic ODA ASI builder 624. Generic ODA ASI builder 624 matches the ODA meta BOs with the schema meta BOs. The matched parts of the ODA meta BOs receive schema annotation information from the schema meta BOS. However, for each unmatched part, specific ODA ASI builder 626 is asked whether a set of transformation rules 628, specifying how one part may be matched with another, are registered. More detail regarding how generic ODA ASI builder matches ODA meta BOs with schema meta BOs is discussed in FIG. 10.

If transformation rules 628 are registered with specific ODA ASI builder 626, the schema annotation is augmented by generic ODA ADI builder 624 with the schema transformation specified by transformation rules 628. However, if no transformation rules are registered with specific ODA ASI builder 626, the user may be able to match the parts with a suitable front-end application or add transformation rules for recurring patterns.

Once the ODA meta BOs are matched with schema meta BOs, specific BO ASI builder 626 may fine tune the target meta BOs if desired. The target meta BOs with proper schema annotation from the generic meta BOs are then sent back to BO ASI resolver 616. Optionally, BO writer 618 may write out target meta BOs 612, such as SAP BOs, as application specific business object and SAP configuration data structures 614. In general, application specific business objects generated by ODA are fully functional on their own and there is no need to write out the specific business objects again. Writing out the specific BOs is an option, however, if additional fine tuning is needed that ODA did not do in the first place.

Turning now to FIG. 7, a diagram illustrating an exemplary meta business object generated by a schema resolver is depicted in accordance with an illustrative embodiment of the present invention. As shown in FIG. 7, schema meta BO 700 includes fields 702. Each of fields 702 includes a field name and a field type. Field name indicates the name of a schema element or attribute, for example, street. Field type indicates the type of the schema element or attribute, for example, string, integer or date.

Schema meta BO 700 also includes business object level application specific information (BO ASI) field 704, which provides mapping information between the application specific business object and the meta BO. For each field in fields 702, field ASI 704 is associated. Field ASI 704 holds field level application specific information.

BO ASI 704 and each of fields 702 associate with schema information 708, which refers back to schema specific constructs, such as whether the field type was a simple type, a complex type, whether the field is an extension or a restriction, and other schema information. These schema constructs relate the fields 702 back to their location in the schema. The name of the schema information is usually the same as the name of the schema element or attribute.

BO ASI 704 and each of fields 702 also associate with schema reference 710, which holds a pointer back to the physical schema document in order for the schema annotation parser to retrieve context information that is only available in the schema itself.

Turning now to FIG. 8, a functional diagram illustrating an exemplary application specific business object is depicted in accordance with an illustrative embodiment of the present invention. As shown in FIG. 8, specific application ODA connects to the application using configuration data prepared by the specific ODA ASI builder.

An ODA, such as SAP ODA, generates application specific business object 800 that can be used by the integration broker at run time. Application specific business object 800 includes fields 802, matching field ASI 804, and business object level ASI 806. In addition to application specific business object 800, the ODA may generate supporting structures and configuration files, such as Java classes that are not shown in the diagram.

Turning now to FIG. 9, a functional diagram illustrating an exemplary mapping of application specific business object to meta business object generated by a BO reader is depicted in accordance with an illustrative embodiment of the present invention. As depicted in FIG. 9, BO reader reads application specific business objects, such as business object 800, generated by specific application ODA and converts the application specific business objects into meta business objects (BOs), such as meta BO 900.

Based on what specific application ODA returns, schema relevant information may not be determined. Thus, the schema information may only be partly reconstituted in cases where an XML ODA with a matching schema file is called. In this example, BO reader generates meta BO 900, which includes only fields 802, field ASI 804, and BO ASI 806 from application specific business object 800.

Turning now to FIG. 10, a functional diagram illustrating an exemplary mapping of schema meta BOs to ODA meta BOs is depicted in accordance with an illustrative embodiment of the present invention. As depicted in FIG. 10, generic ODA ASI builder mediates schema meta BOs with ODA meta BOs by populating the schema information from the schema meta BO in the ODA meta BO. An example of schema meta BO may be schema meta BO 700 in FIG. 7. An example of ODA meta BO may be ODA meta BO 900 in FIG. 9.

The generic ODA ASI builder examines schema meta BO 700 and ODA meta BO 900 and then determines if their fields match. If their fields match, the schema information and references are ported directly from the schema meta BO to the target meta BO. For example, schema information 708 is ported to schema information 908 and schema reference 710 is ported to schema reference 910.

However, if the fields do not match, either the name, type, or other mismatch, and if there is transformation rule 912, the schema information and references are updated and set in the target meta BO. If there is no transformation rule 912, a user may either construct a rule or resolve the mismatch for one particular case.

Field and BO mismatches happen when the application through which the specific ODA generates its application specific business objects is not in synchronization with the schema that describes the same application domain. Mismatches may be a known divergence and corresponding transformation rules can be constructed that match particular fields or cases can be examined one by one by the user. Mismatches may also be on the business object level, where one full business object does not match at all to the ODA meta BO. Business object level mismatches may occur where an inheritance in the schema case is modeled as containment in the application case. If these patterns are known, transformation rules may be applied at the business object level.

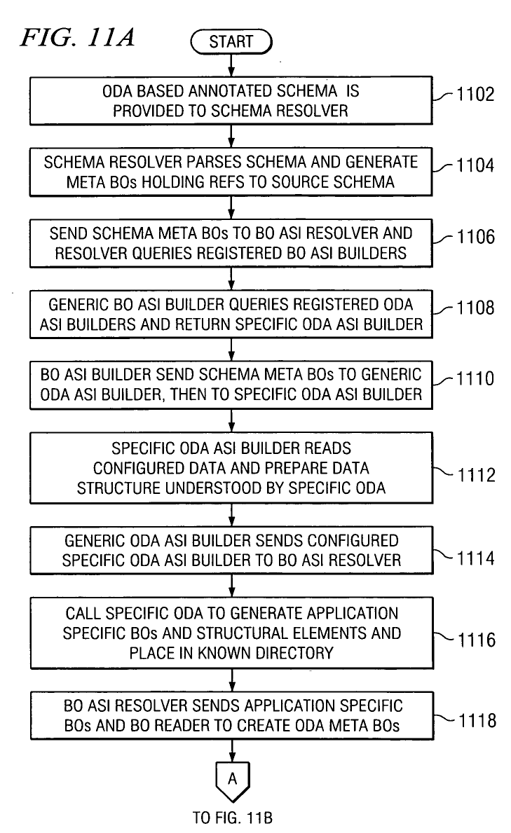

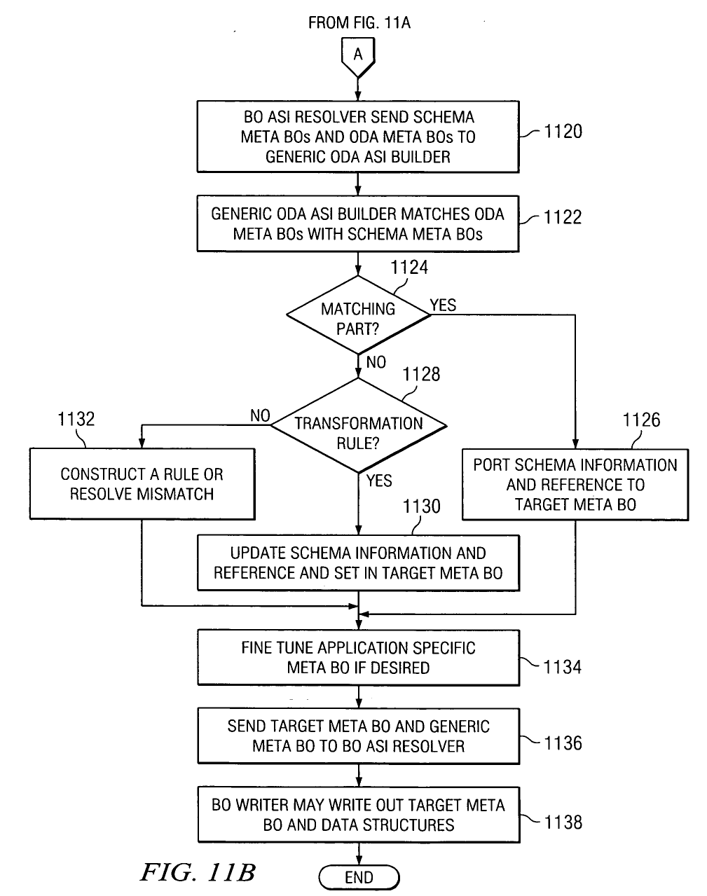

Turning now to FIG. 11A, a flowchart of an exemplary process for object discovery agent based mapping of application specific markup language schemas to application specific business objects using an appropriate ODA is depicted in accordance with an illustrative embodiment of the present invention. As shown in FIG. 11A, the process begins when an ODA based annotated schema, such as SAP schema, is provided to a schema resolver (step 1102).

The schema resolver parses the schema and generates business objects that hold references to the source schema (step 1104). The generated BOs are then sent to the BO ASI resolver, which queries its registered BO ASI builder to handle the meta BOs (step 1106). The BO ASI builder queries the registered ODA ASI builders and returns a specific ODA ASI builder that handles the particular type of schema definition (step 1108).

Once a specific ODA ASI builder is located, the BO ASI resolver sends the schema meta BOs to the generic ODA ASI builder, which in turn sends them to the specific ODA ASI builder (step 1110). The specific ODA ASI builder reads configuration data from the meta BOs and prepares a data structure understood by the specific ODA, such as a SAP ODA (step 1112).

The generic ODA ASI builder then sends the configured specific ODA ASI builder to the BO ASI resolver (step 1114), which calls the specific ODA to generate application specific BOs and structural elements and place them in a known target directory (step 1116). The BO ASI resolver then sends the application specific BOs to the BO reader in order to create ODA meta BOs (step 1118). The process then continues to step 1120 in FIG. 11B.

Turning now to FIG. 11B, a flowchart of the exemplary process in continuation of FIG. 11A for object discovery agent based mapping of application specific markup language schemas to application specific business objects using an appropriate ODA is depicted in accordance with an illustrative embodiment of the present invention. As shown in FIG. 11B, once the ODA meta BOs are created, the BO ASI resolver sends the schema meta BOs and the ODA meta BOs to the generic ODA ASI builder (step 1120). The generic ODA ASI builder then matches the ODA meta BOs with the schema meta BOs (step 1122) and determines if matching part exists (step 1124). If matching part exists, the generic ODA ASI builder ports the schema information and reference from the schema meta BO to the target meta BO (step 1126) and continues to step 1134.

However, if no matching part exists, the generic ODA ASI builder determines if a transformation rule is present (step 1128). If a transformation rule is present, the generic ODA ASI builder updates the schema information and reference and sets them in the target meta BO (step 1130) and the process continues to step 1134. However, if no transformation rule is present, a user may construct a rule or resolve any mismatch manually (step 1132) and continues to step 1134.

At step 1134, the specific ODA ASI builder may fine tune the target meta BO if desired. The specific ODA ASI builder may then send the target meta BO and generic meta BO to BO ASI resolver (step 1136). Optionally, the BO writer may write out target meta BO and configuration data structures (step 1138).

Thus, the present invention provides an improved method for ODA based mapping of application specific markup language schemas to application specific business objects. With the addition of a generic ODA ASI builder, common algorithms and structures may be reused, since the matching of schema meta BOs and ODA meta BOs is now located in the generic ODA ASI builder. In addition, the generic ODA ASI builder may register different ODA ASI builders and orchestrates data flow between the BO ASI resolver and the specific ODA ASI builders, while not actually having to perform the algorithm.

Furthermore, the generic ODA ASI builder may now act as a registry of specific ODA ASI builders. This allows assembly of application specific logic, like ODA configuration, in the individual ODA ASI builders. Moreover, by allowing transformation rules to be part of the generic ODA ASI builder, mismatches may be resolved within the specific ODA ASI builder, since the actual rule instance is registered within the specific ODA ASI builder.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal-bearing media actually used to carry out the distribution. Examples of computer readable media include recordable-type media, such as a floppy disc, a hard disk drive, a RAM, and CD-ROMs, and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for object discovery agent based mapping of application specific markup language schemas to application specific business objects, the method comprising:
detecting an application specific markup language schema;
responsive to detecting the application specific markup language schema, generating a set of schema meta business objects, wherein the set of schema meta business objects hold references to metadata of the schema; and
identifying a generic object discovery agent application specific information builder, from a set of object discovery agent application specific information builders, wherein the generic object discovery agent application specific information builder includes a plurality of specific object discovery agent application specific information builders.

2. The method of claim 1, further comprising:
identifying a specific object discovery agent application specific information builder from the plurality of specific object discovery agent application specific information builders based on a type of an application;
reading configuration data of the schema meta business objects; and
generating a data structure understandable by a specific object discovery agent, wherein the specific object discovery agent generates business objects and support structures for communication with the application.

3. The method of claim 2, further comprising:
generating a set of application specific business objects using the data structure;
creating a set of object discovery agent meta business objects from the set of application specific business objects; and
matching the set of schema meta business objects against the set of object discovery agent meta business objects.

4. The method of claim 3, wherein the matching step comprises:
determining if a part of an object discovery agent meta business object matches a part of a schema meta business object;
if a part of an object discovery agent meta business object matches a part of a schema meta business object, porting schema information and references from the schema meta business object to a target meta business object; and
if a part of an object discovery agent meta business object does not match a part of a schema meta business object, determining if a transformation rule is present, wherein the transformation rule specifies how a part of an object discovery agent meta business object is matched with a part of a schema meta business object.

5. The method of claim 4, further comprising:
if transformation rule is registered with the specific business object application specific information builder, updating schema information and references of the target meta business object based on the transformation rule; and
if no transformation rule is present, constructing a new transformation rule to resolve the mismatch.

6. The method of claim 3, further comprising:
fine-tuning a set of target meta business objects if desired; and
writing out the set of target meta business objects and configuration and configuration data structures.

7. The method of claim 1, wherein the detecting and generating steps are performed by a schema resolver and wherein the first identifying step is performed by a business object application specific information resolver.

8. The method of claim 2, wherein the second identifying step is performed by the generic object discovery agent application specific information builder and wherein the reading and the second generating steps are performed by the specific object discovery agent application specific information builder.

9. The method of claim 3, wherein the third generating step is performed by the specific object discovery agent, wherein the creating step is performed by a business object reader, and wherein the matching step is performed by the generic object discovery agent application specific information builder.

10. The method of claim 6, wherein the fine-tuning step is performed by the specific object discovery agent application specific information builder, and wherein the writing step is performed by a business object writer.

11. A data processing system comprising:
a bus;
a memory connected to the bus, wherein a set of instructions are located in the memory; and
a processor connected to the bus, wherein the processor executes the set of instructions to detect an application specific markup language schema, generate a set of schema meta business objects responsive to detecting the application specific markup language schema, wherein the set of schema meta business objects hold references to metadata of the schema, and identify a generic object discovery agent application specific information builder, from a set of object discovery agent application specific information builders, wherein the generic object discovery agent application specific information builder includes a plurality of specific object discovery agent application specific information builders.

12. The data processing system of claim 11, wherein the processor further executes the set of instructions to identify a specific object discovery agent application specific information builder from the plurality of specific object discovery agent application specific information builders based on a type of an application, read configuration data of the schema meta business objects, and generate a data structure understandable by a specific object discovery agent, wherein the specific object discovery agent generates business objects and support structures for communication with the application.

13. The data processing system of claim 12, wherein the processor further executes the set of instructions to generate a set of application specific business objects using the data structure, create a set of object discovery agent meta business objects from the set of application specific business objects, and match the set of schema meta business objects against the set of object discovery agent meta business objects.

14. The data processing system of claim 13, wherein the processor, in executing the set of instructions to match the set of schema meta business objects against the set of object discovery agent meta business objects, determines it a part of an object discovery agent meta business object matches a part of a schema meta business object, ports schema information and references from the schema meta business object to a target meta business object, if a part of an object discovery agent meta business object matches a part of a schema meta business object, and determines if a transformation rule is present, wherein the transformation rule specifies how a part of an object discovery agent meta business object is matched with a part of a schema meta business object, if a part of an object discovery agent meta business object does not match a part of a schema meta business object.

15. The data processing system of claim 14, wherein the processor, in executing the set of instructions to match the set of schema meta business objects against the set of object discovery agent meta business objects, updates schema information and references of the target meta business object based on the transformation rule, if transformation rule is registered with the specific business object application specific information builder, and constructs a new transformation rule to resolve the mismatch if no transformation rule is present.

16. The data processing system of claim 13, wherein the processor further executes the set of instructions to fine-tune a set of target meta business objects if desired, and write out the set of target meta business objects and configuration and configuration data structures.

17. A computer program product in a computer readable medium for object discovery agent based mapping of application specific markup language schemas to application specific business objects, the computer program product comprising:
first instructions for detecting an application specific markup language schema;
second instructions for generating a set of schema meta business objects responsive to detecting the application specific markup language schema, wherein the set of schema meta business objects hold references to metadata of the schema; and
third instructions for identifying a generic object discovery agent application specific information builder, from a set of object discovery agent application specific information builders, wherein the generic object discovery agent application specific information builder includes a plurality of specific object discovery agent application specific information builders.

18. The computer program product of claim 17, further comprising:
fourth instructions for identifying a specific object discovery agent application specific information builder from the plurality of specific object discovery agent application specific information builders based on a type of an application;
fifth instructions for reading configuration data of the schema meta business objects; and
sixth instructions for generating a data structure understandable by a specific object discovery agent, wherein the specific object discovery agent generates business objects and support structures for communication with the application.

19. The computer program product of claim 18, further comprising:
seventh instructions for generating a set of application specific business objects using the data structure;
eighth instructions for creating a set of object discovery agent meta business objects from the set of application specific business objects; and
ninth instructions for matching the set of schema meta business objects against the set of object discovery agent meta business objects.

20. The computer program product of claim 19, further comprising:
tenth instructions for fine-tuning a set of target meta business objects if desired; and
eleventh instructions for writing out the set of target meta business objects and configuration and configuration data structures.
